(19) United States
(12) Patent Application Publication
(10) Pub. No.: US 2005/0076960 A1
(43) Pub. Date: Apr. 14, 2005

(54) Mixing faucet

(75) Inventors: Frank-Thomas Luig, Menden (DE); Stefan Steinhoff, Sundern (DE); Thomas Salomon, Gutersloh (DE); Stefan Salomon, Bielefeld (DE); Karl-Heinz Stuckerjurgen, Verl (DE); Jorg Schmidt, Verl (DE)

Correspondence Address: THE FIRM OF KARL F ROSS, 5676 RIVERDALE AVENUE, PO BOX 900, RIVERDALE (BRONX), NY, 10471-0900, US

(73) Assignee: GROHE WATER TECHNOLOGY AG & Co. KG

(21) Appl. No.: 10/947,477

(22) Filed: Sep. 22, 2004

(30) Foreign Application Priority Data
Oct. 10, 2003 (DE) 10347819.1

(51) Int. Cl. F16K 11/20

(52) U.S. Cl. 137/606

(57) ABSTRACT

A mixing valve has a housing, hot- and cold-water valves in the housing having respective valve stems rotatable about respective parallel axes, respective drive gears fixed on the stems, respective hot- and cold-water control elements pivotal on the housing, and respective coupling gears each connected to a respective one of the control elements and meshing with a respective one of the drive gears. The coupling gears each have a pair of gear segments of different effective radii, one of the gear segments of each coupling gear meshing with the respective valve drive gear and the other gear segment with the respective control element. The radii are such that the coupling gears create a step-down ratio of about 1:1.6.

### FIELD OF THE INVENTION

The present invention relates to mixing faucet.

### BACKGROUND OF THE INVENTION

A standard mixing valve has a housing formed with hot- and cold-water inlet ports and at least one outlet port, hot- and cold-water valves in the housing having respective valve stems rotatable about respective parallel axes, respective drive gears fixed on the stems and respective hot- and cold-water control elements pivotal on the housing and connected to the gears. As described in German patent document 3,820,855 of G. Ottelli and related U.S. Pat. No. 5,299,593 also of G. Ottelli, the drive gears mesh directly with ring-gear segments formed inside a common control knob. Thus operating the valve takes considerable effort and, with time, becomes even more difficult.

### OBJECTS OF THE INVENTION

It is therefore an object of the present invention to provide an improved mixing valve.

Another object is the provision of such an improved mixing valve which overcomes the above-given disadvantages, that is which is easy to operate over its service life.

### SUMMARY OF THE INVENTION

A mixing valve has according to the invention a housing, hot- and cold-water valves in the housing having respective valve stems rotatable about respective parallel axes, respective drive gears fixed on the stems, respective hot- and cold-water control elements pivotal on the housing, and respective coupling gears each connected to a respective one of the control elements and meshing with a respective one of the drive gears.

According to the invention the coupling gears each have a pair of gear segments of different effective radii, one of the gear segments of each coupling gear meshing with the respective valve drive gear and the other gear segment with the respective control element. The radii are such that the coupling gears create a step-down ratio of about 1:1.6.

Thus with the system of this invention there is a significant step-down between the travel of the actuating element and the travel of the valve. Since most cartridge valves have a relatively limited angular stroke, typically about 90° from full-off to full-on, the system of this invention allows a pivotal actuating element coupled via the coupling gear to the gear on the valve stem to pivot through a much larger angle between full-off and full-on, requiring less torque and making it possible to accurately set the valve flow rate.

In accordance with the invention the drive gear and gear segments of the hot-water valve are offset axially from the drive gear and gear segments of the cold-water valve. These coupling gears are coaxial.

The housing according to the invention has hot-and cold-water inlet ports connected to the respective valves, forms a chamber, and includes structure joining the valves together and securing them in the chamber over the ports. This structure includes respective seats holding the valves and respective retaining rings fixedly securing the valves in the respective seats. Furthermore the housing has an upper part forming a compartment open toward the valves and a lower part holding the valves. The compartment contains the coupling and drive gears and has upper and lower end surfaces between which the coupling gears are confined coaxially. Screws retain the upper part on the lower part. A shaft in the compartment carries both of the coupling gears and is seated in the upper part.

The drive gears according to the invention each have an outer end and the upper part is formed with seats complementarily receiving the outer ends. These outer ends are ball shaped. The housing is centered on an axis and includes a passage extending from an inlet compartment at the valves to an outlet end at the axis.

Each valve stem in accordance with the invention is rotatable only through a predetermined angle. The drive gears are segments at least some of which only extend through the predetermined angle. Each drive gear is provided with an alignment formation.

The control elements are concentric rings rotatable about a common axis on the housing and formed with teeth meshing with the respective coupling gears. Each of the rings is provided with an outwardly extending actuating arm.

### BRIEF DESCRIPTION OF THE DRAWING

The above and other objects, features, and advantages will become more readily apparent from the following description, reference being made to the accompanying drawing in which:

FIG. 1 is a perspective view of the faucet according to the invention;

FIG. 2 is a vertical axial section through the body of the faucet;

FIG. 3 is an axial section taken along line III-III of FIG. 2;

FIG. 4 is a cross section taken along line IV-IV of FIG. 2;

FIG. 5 is a perspective view of the lower elements of the dual-valve cartridge of the faucet;

FIG. 6 is a view of the complete dual-valve cartridge;

FIGS. 7, 8, and 9 are perspective, top, and side views of one of the coupling gears in accordance with the invention;

FIGS. 10, 11, and 12 are perspective, side, and top views of the cold-water control gear; and

FIGS. 13, 14, and 15 are perspective, side, and top views of the hot-water control gear.

### SPECIFIC DESCRIPTION

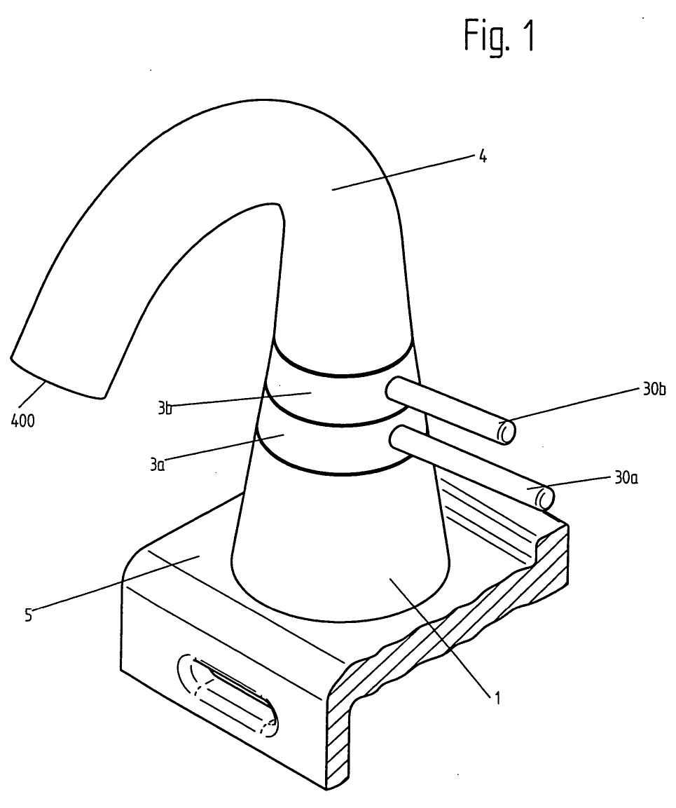

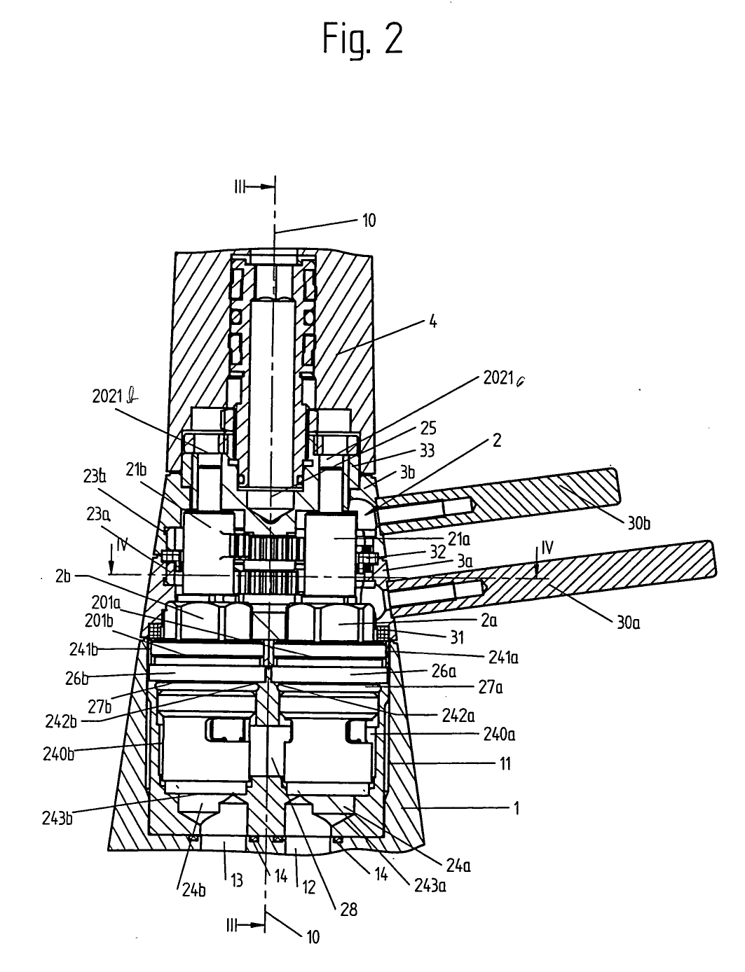

As seen in FIG. 1 a faucet basically comprises a base 1 fixed on a counter 5, here the edge of a sink. A lower cold-water adjustment ring 3a and an upper hot-water adjustment ring 3b are rotatable about a vertical axis 10 (FIG. 2) on the base 1 and a spout 4 is similarly pivoted atop the upper ring 3b. This spout 4 has a mouth 400 and can be less arcuate for wall mounting of the faucet, that is with the axis 10 horizontal. The rings 3a and 3b carry radially projecting arms 30a and 30b serving for adjusting the volume/flow rate of the cold and hot water.

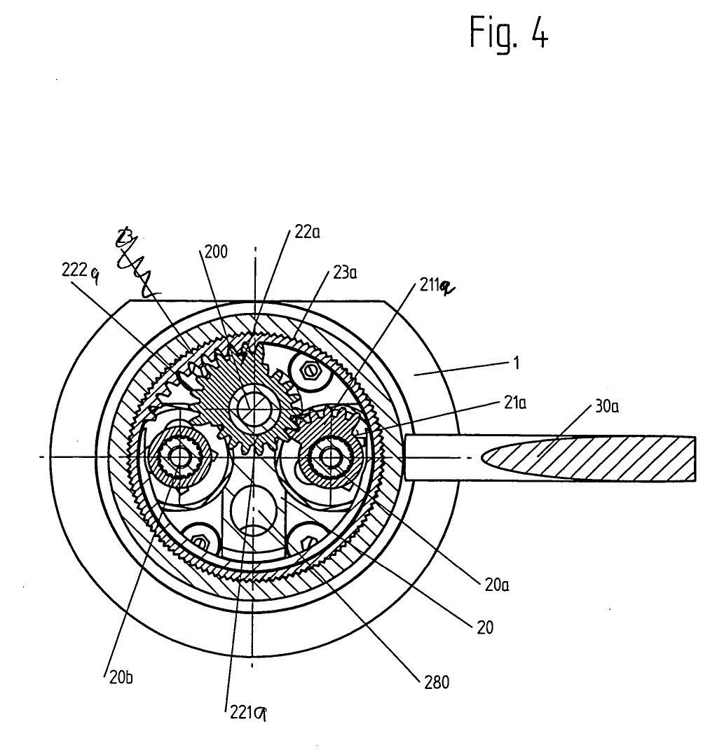

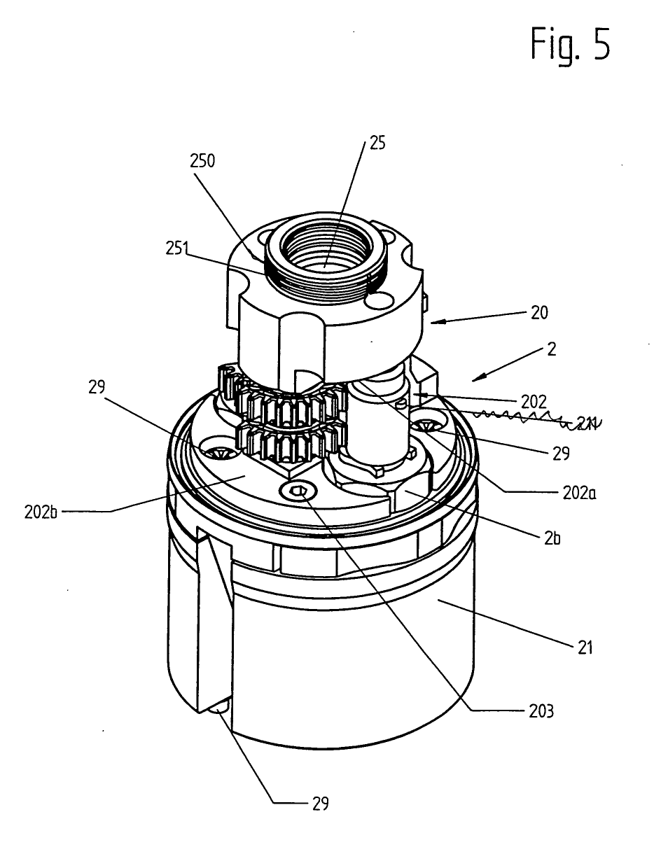

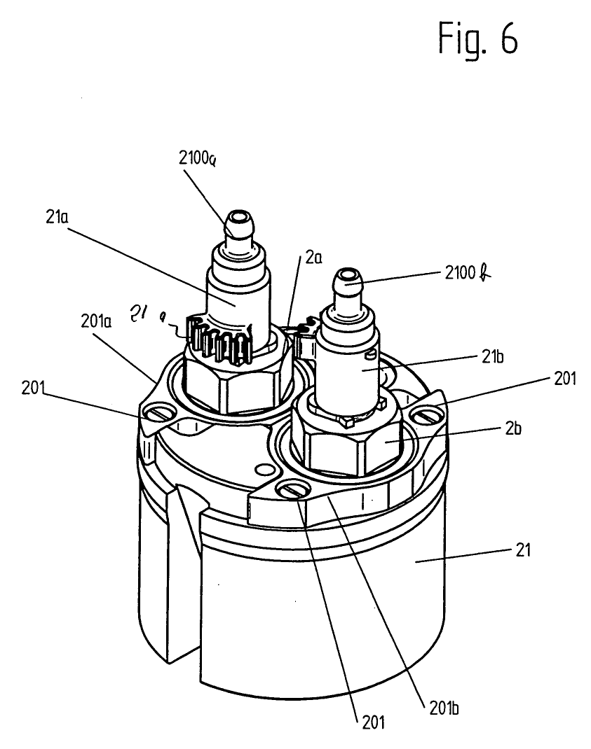

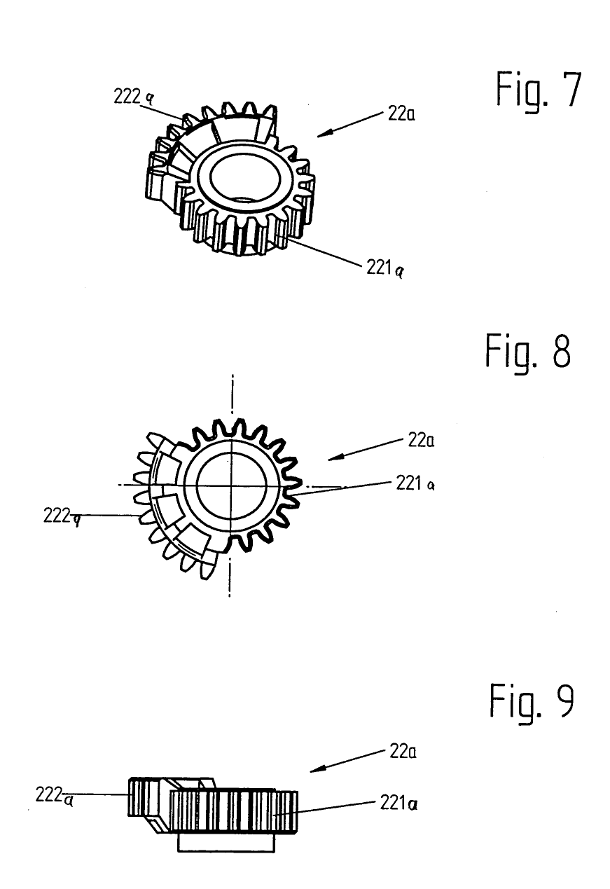

The base 1 has a chamber 11 holding a dual-cartridge assembly 2 comprised of upper and lower parts 20 and 21 secured by screws 29 to the base 1 (see also FIGS. 5 and 6). Ports 12 and 13 in the bottom of the base 1 admit cold and hot water, communicating via respective passages 24a and 24b with lower ends 243a and 243b of valves 2a and 2b fitting in seats 240a and 240b in the lower part 20 and having respective stems 20a and 20b extending upward parallel to the axis 10. Seals 14 around the ports 12 and 13 prevent leakage. Each of the stems 20a and 20b can be turned between off and full-on positions through 900 to control the position of a standard unillustrated ceramic flow-control disk, with intermediate positions having correspondingly intermediate flow rates.

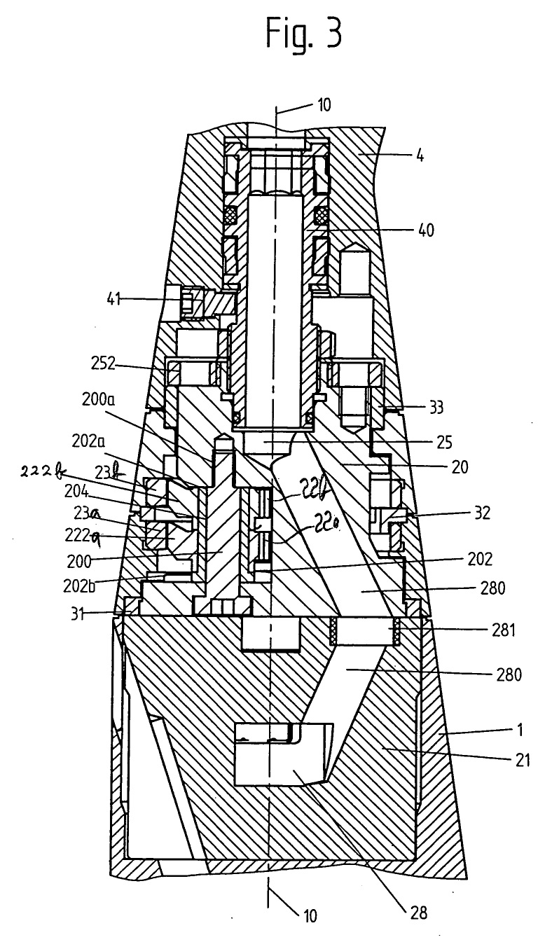

The hot- and cold-water flows from the valves 2a and 2b go into a mixing compartment 28 (FIG. 2) whence as shown in FIG. 3 the mixed water passes through passages 280 in the body parts 20 and 21 to an outlet port 25 at the axis 10 and opening into the spout 4, with a seal 281 around the passage 280 between the parts 20 and 21. Unillustrated splines connect the stems 20a and 20b to the internal works of the respective valves 2a and 2b. Respective retaining rings 201a and 201b secured by screws 201 to the lower part 21 bear on projecting ridges 26a and 26b (FIG. 2) to press them against shoulders 242a and 242b of seats 241a and 241b and secure the valves 2a and 2b in the seats 240a and 240b. O-rings 27a and 27b seal around the valves 2a and 2b in the respective seats 240a and 240b.

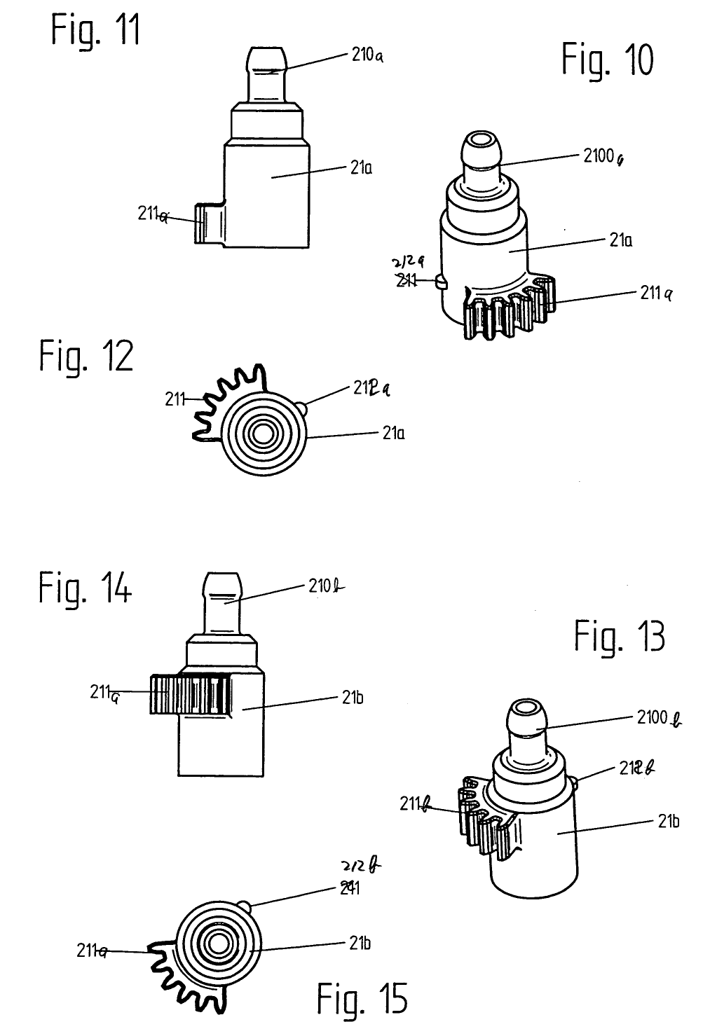

The valve stems 20a and 20b are splined as best shown in FIG. 4 to respective drive gears 21a and 21b having as shown in FIGS. 10-15 respective gear segments 211a and 211b. The gear segment 211a is offset axially well above the gear segment 211b so they cannot touch each other. The gears 21a and 21b also carry respective bumps 212a and 212b that serve for properly aligning the gears 21a and 21b when they are being installed on the stems 20a and 20b. Upper ends 210a and 210b of the gears 21a and 21b are generally ball-shaped and have rounded outer surfaces 2100a and 2100b that fit into seats 2021a and 2021b (FIG. 2) in the upper end of the part 20, which is complexly shaped with upper and lower end portions connected by an narrow web in which the upper passage 280 is formed (FIG. 3).

These two end portions of the upper base part 20, which is secured atop the lower part 21 by screws 203, defines a cavity 202 having an upper downwardly directed inner face 202a and a lower upwardly directed face 202b. A pivot shaft 200 has an upper end 200a threaded into the part 20 and carries a sleeve 204 extending between the faces 202a and 202b and positioned equidistant between the axes of the stems 20a and 20b. Independent but coaxial coupling gears 22a and 22b on the sleeve 204 have respective diametrally opposite gear segments 221a, 222a and 221b, 222b. The segments 221a and 221b extend over quite a bit more than 180° and mesh with the respective gear segments 211a and 211b of the gears 21a and 21b.

As shown in FIGS. 2 and 3, the lower cold-water adjustment ring 3a sits via a bearing ring 31 on the upper end of the cartridge assembly 2 and is fixed to a ring gear 23a (FIG. 4) meshing with the toothed segment 222a of the coupling gear 22a whose teeth 221a mesh with the toothed segment 211a of the drive gear 21a. Similarly the upper hot-water adjustment ring 3b sits via another bearing ring 32 on the lower ring 3b and is fixed to a ring gear 23b meshing with the toothed segment 222b of the coupling gear 22b whose teeth 221b mesh with the toothed segment 211b of the drive gear 21b. The gearing is such that there is a ratio of 1:1.6, so that for example the arm 30a for cold water is moved through an arc of about 140° to rotate the respective valve 2a through its full angular stroke of 90°, giving the user the ability to control flow rather accurately.

Another bearing ring 33 is centered on the axis A atop the ring 3b and fits in the lower end of the spout 4 to keep them coaxial while allowing them to rotate freely relative to each other about the axis 10. FIG. 5 shows how an upper end 250 of the cartridge assembly 2 has an external thread 251 to which is fitted a nut 252 (FIG. 3) bearing down on the bearing ring 33 and serving to adjust the axial play of the rings 3a and 3b and how tightly they engage each other.

A short tubular nipple 40 (FIG. 3) is threaded into the upper part 20 on the axis A and is axially coupled to the spout 4 by a screw 41. In addition a collar 250 of this upper part 20 that forms the port or passage 25 and that carries a nut 252 (FIG. 3) that bears downward on a ring 34 to set the tightness of the rings 3a and 3b.

1. A mixing valve comprising:
a housing;
hot- and cold-water valves in the housing having respective valve stems rotatable about respective parallel axes;
respective drive gears fixed on the stems;
respective hot- and cold-water control elements pivotal on the housing; and
respective coupling gears each connected to a respective one of the control elements and meshing with a respective one of the drive gears.

2. The mixing valve defined in claim 1 wherein the coupling gears each have a pair of gear segments of different effective radii, one of the gear segments of each coupling gear meshing with the respective valve drive gear and the other gear segment with the respective control element.

3. The mixing valve defined in claim 2 wherein the radii are such that the coupling gears create a step-down ratio of about 1:1.6.

4. The mixing valve defined in claim 2 wherein the drive gear and gear segments of the hot-water valve are offset axially from the drive gear and gear segments of the cold-water valve.

5. The mixing valve defined in claim 4 wherein the coupling gears are coaxial.

6. The mixing valve defined in claim 1 wherein the housing has hot-and cold-water inlet ports connected to the respective valves, forms a chamber, and includes structure joining the valves together and securing them in the chamber over the ports.

7. The mixing valve defined in claim 6 wherein the structure includes respective seats holding the valves and respective retaining rings fixedly securing the valves in the respective seats.

8. The mixing valve defined in claim 6 wherein the housing has an upper part forming a compartment open toward the valves and a lower part holding the valves.

9. The mixing valve defined in claim 8 wherein the compartment contains the coupling and drive gears.

10. The mixing valve defined in claim 9 wherein the compartment has upper and lower end surfaces between which the coupling gears are confined coaxially.

11. The mixing valve defined in claim 10, further comprising screws retaining the upper part on the lower part.

12. The mixing valve defined in claim 10, further comprising
a shaft in the compartment carrying both of the coupling gears and seated in the upper part.

13. The mixing valve defined in claim 8 wherein the drive gears each have an outer end and the upper part is formed with seats complementarily receiving the outer ends.

14. The mixing valve defined in claim 13 wherein the outer ends are ball shaped.

15. The mixing valve defined in claim 1 wherein the housing is centered on an axis and includes a passage extending from an inlet compartment at the valves to an outlet end at the axis.

16. The mixing valve defined in claim 1 wherein each valve stem is rotatable only through a predetermined angle, the drive gears being segments at least some of which only extend through the predetermined angle.

17. The mixing valve defined in claim 1 wherein each drive gear is provided with an alignment formation.

18. The mixing valve defined in claim 1, further comprising screws bolting the valves to the housing.

19. The mixing valve defined in claim 1 wherein the control elements are concentric rings rotatable about a common axis on the housing and formed with teeth meshing with the respective coupling gears.

20. The mixing valve defined in claim 19 wherein each of the rings is provided with an outwardly extending actuating arm.
